(19) United States
(12) Patent Application Publication
(10) Pub. No.: US 2018/0253503 A1
(43) Pub. Date: Sep. 6, 2018

(54) Method, Apparatus and System for Preloading of APP Launch Advertising

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Junshuang GAO, BEIJING (CN); Weibo AO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/120,265

(22) PCT Filed: May 26, 2016
(86) PCT No.: PCT/CN2016/083546

§ 371 Date: Aug. 19, 2016

(30) Foreign Application Priority Data
Nov. 23, 2015 (CN) 201510821272.2

(51) Int. Cl. G06F 17/30; G06Q 30/02

(52) U.S. Cl. CPC G06F 17/30902; G06Q 30/0272

(57) ABSTRACT

Disclosed is a method, apparatus and system for preloading of APP launch advertising, comprising: detecting whether the local advertising cache is null when an APP is launched; if yes, then executing an initialization step; if no, then executing a standard step; wherein the initialization step comprising: entering the homepage of the APP and sending an advertising request to an advertising server; and receiving advertising data returned from the advertising server and storing the advertising data into the local advertising cache; wherein the standard step comprising: displaying the advertising data stored in the local advertising cache and then sending an advertising request to the advertising server; and receiving the advertising data returned from the advertising server.

### CROSS-REFERENCE TO RELATED APPLICATIONS

This application is a continuation of International Application No. PCT/CN2016/083546, filed May 26, 2016, which is based upon and claims priority to Chinese Patent Application No. 201510821272.2, filed Nov. 23, 2015, the entire contents of all of which are incorporated herein by reference.

### FIELD OF TECHNICAL

The present disclosure relates to APP's advertising loading technology, in particular to a method, apparatus and system for preloading of APP launch advertising.

### BACKGROUND

Currently, it is a common advertising display mode that when launching an APP, a few seconds of advertising will be loaded firstly and then entering the homepage of the APP. In the prior art, such launch advertising conventionally employs a mode of loading and displaying in real time, that is, the launch advertising will be displayed immediately once it is loaded by the advertising backend system, which can affect the user's experience and the advertising display efficiency to a certain extent at the time of launching an APP. If the network circumstance is poor, the loading speed and performance of advertising will be reduced, resulting in that the loading speed of advertising is very slow or failed to display, which will seriously affect the user's experience of client end and the effect and efficiency of advertising display.

### SUMMARY

In view of this, an object of the present disclosure is to provide a method, apparatus and system for preloading of APP launch advertising to improve the effect and efficiency of advertising display and enhance the user's experience.

Based on the above described object, the present disclosure provides a method for preloading of APP launch advertising, the method as an embodiment includes:

detecting whether the local advertising cache is null when an APP is launched; if yes, then executing a initialization step; if no, then executing a standard step;
wherein the initialization step includes:
entering the homepage of the APP and sending an advertising request to an advertising server; and
receiving advertising data returned from the advertising server and storing the advertising data into the local advertising cache;
the standard step includes:
displaying the advertising data stored in the local advertising cache and then sending an advertising request to the advertising server; and
receiving the advertising data returned from the advertising server.

In some embodiments, the method further includes:

sending an exposure data to a monitoring server after the display of the exposure data, wherein the exposure data is used for statistics of the advertising display situation by the monitoring server.

In some embodiments, the step of sending an exposure data to the monitoring server at network further includes:

checking whether the network communicating connection with the monitoring server; is established if yes, then sending the exposure data to the monitoring server directly; if no, then storing the exposure data in local and sending the exposure data to the monitoring server once the network communicating connection with the monitoring server is established.

In some embodiments, the standard step further includes:

determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

In some embodiments, the standard step further includes:

analyzing a duration attribute of the advertising data returned from the advertising server; and
determining whether the duration attribute is matched with a preset advertising display duration; if yes, then updating the advertising data in the local advertising cache to the advertising data returned from the advertising server; if no, then abandoning update of the local advertising cache.

In some embodiments, before displaying the advertising data stored in the local advertising cache, the method further includes:

analyzing a content attribute of the acquired advertising data; and
searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache.

In some embodiments, the standard step further includes:

synchronizing the association list in local with that in the advertising server at the time of sending the advertising request to the advertising server.

Another aspect of the present disclosure also provides an apparatus for preloading of APP launch advertising, the apparatus as an embodiment includes:

a local advertising cache unit, for storing advertising data;
a detecting unit; for detecting whether the local advertising cache unit is null when an APP is launched;
a sending unit, for sending an advertising request to an advertising server;
a receiving unit, for receiving the advertising data returned from the advertising server;
an executing unit, for if it is detected by the detecting unit that the local advertising cache is null, then entering the homepage of the APP and making the sending unit to send an advertising request to the advertising server; and if it is detected by the detecting unit that the local advertising cache is not null, then displaying the advertising data stored in the local advertising cache unit and then making the sending unit to send an advertising request to the advertising server; and making the receiving unit to receive the advertising data returned from the advertising server.

In some embodiments, the apparatus further includes an exposure data sending unit, for sending an exposure data to a monitoring server after the display of the exposure data, wherein the exposure data is used for statistics of the advertising display situation by the monitoring server.

In some embodiments, the exposure data sending unit is further used for checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

In some embodiments, the apparatus further includes a determining unit, for determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

In some embodiments, he apparatus further includes a analyzing and marching unit, for analyzing a duration attribute of the advertising data returned from the advertising server; and determining whether the duration attribute is matched with a preset advertising display duration; if yes, then updating the advertising data in the local advertising cache to the advertising data returned from the advertising server; if no, then abandoning update of the local advertising cache.

In some embodiments, the apparatus further includes an associating unit, for analyzing a content attribute of the acquired advertising data before displaying the advertising data stored in the local advertising cache; and searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then display the advertising data stored in the local advertising cache directly.

In some embodiments, the associating unit is further used for synchronizing the association list in local with that in the advertising server at the time of sending the advertising request to the advertising server.

Further another aspect of the present disclosure also provides a system for preloading of APP launch advertising, the system as an embodiment includes: an advertising server and a terminal, wherein:

the advertising server is used for sending an advertising data to the terminal when receiving an advertising request of the terminal;
the terminal is used for if it is detected that the local advertising cache is null, then entering the homepage of the APP and sending an advertising request to the advertising server; and receiving the advertising data returned from the advertising server and storing the data into the local advertising cache; and if it is detected that the local advertising cache is not null, then displaying the advertising data stored in the local advertising cache and then sending an advertising request to the advertising server; and receiving the advertising data returned from the advertising server.

In some embodiments, the terminal is further used for sending an exposure data to a monitoring server after the display of the exposure data, wherein the exposure data is used for statistics of the advertising display situation by the monitoring server.

In some embodiments, the terminal is further used for checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

In some embodiments, the terminal is further used for determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

In some embodiments, the terminal is further used for analyzing a duration attribute of the advertising data returned from the advertising server; and determining whether the duration attribute is matched with a preset advertising display duration; if yes, then updating the advertising data in the local advertising cache to the advertising data returned from the advertising server; if no, then abandoning update of the local advertising cache.

In some embodiments, the terminal is further used for analyzing a content attribute of the acquired advertising data before displaying the advertising data stored in the local advertising cache; and searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache.

In some embodiments, the terminal is further used for synchronizing the association list in local with that in the advertising server at the time of sending the advertising request to the advertising server.

Another aspect of the present disclosure also provides a device, as an embodiment includes:

one or more processor(s); and
a memory for storing an operating instruction;
wherein the one or more processor(s) is/are configured to acquire the operation instruction from the memory to execute:
detecting whether the local advertising cache is null when an APP is launched; if yes, then executing an initialization step; if no, then executing a standard step;
wherein the initialization step includes:
entering the homepage of the APP and sending an advertising request to an advertising server; and
receiving advertising data returned from the advertising server and storing the advertising data into the local advertising cache;
the standard step includes:
displaying the advertising data stored in the local advertising cache and then sending an advertising request to the advertising server; and
receiving the advertising data returned from the advertising server.

In some embodiments, the processor is further used for executing:

sending an exposure data to a monitoring server after the display of the exposure data, wherein the exposure data is used for statistics of the advertising display situation by the monitoring server.

In some embodiments, the processor is further used for executing:

checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

In some embodiments, he processor is further used for executing:

determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

In some embodiments, he processor is further used for executing:

analyzing a duration attribute of the advertising data returned from the advertising server; and
determining whether the duration attribute is matched with a preset advertising display duration; if yes, then updating the advertising data in the local advertising cache to the advertising data returned from the advertising server; if no, then abandoning update of the local advertising cache.

In some embodiments, the processor is further used for executing:

analyzing a content attribute of the acquired advertising data; and
searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache.

In some embodiments, the processor is further used for executing:

synchronizing the association list in local with that in the advertising server at the time of sending the advertising request to the advertising server.

As can be seen from the above, the method, apparatus and system for preloading of APP launch advertising can cache the advertising data from network to the local in advance once an APP is launched, and when the APP is launched at next time, directly display the advertising data stored in the local cache and perform a update of advertising data by communicating with the advertising server at the same time, so as to significantly address the problem of the low display efficiency of APP launch advertising and the poor user's experience in the prior art.

It should be understood that both the descriptions in general and in detailed are exemplary and explanatory without any limit to the disclosure.

### BRIEF DESCRIPTION OF DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn from the drawings without creative efforts.

FIG. 1 is a schematic flow diagram of a method for preloading of APP launch advertising according to an embodiment of the present disclosure;

FIG. 2 is a schematic view of a system for preloading of APP launch advertising according to an embodiment of the present disclosure;

FIG. 3 is a schematic view of an apparatus for preloading of APP launch advertising according to an embodiment of the present disclosure;

FIG. 4 is a schematic flow diagram of a method for preloading of APP launch advertising according to an example of the present disclosure.

The embodiments of the present disclosure have been clearly illustrated through the drawings and will be described in detail hereinafter. These drawings and text description are not intent in any way to limit the scope of the disclosure, but illustrate the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

The embodiments of the present disclosure provide a method for preloading of APP launch advertising, includes:

detecting whether the local advertising cache is null when an APP is launched; if yes, then executing an initialization step; if no, then executing a standard step;
wherein the initialization step includes:
entering the homepage of the APP and sending an advertising request to an advertising server at the same time; and
receiving advertising data returned from the advertising server and storing the data into the local advertising cache;
the standard step includes:
displaying the advertising data stored in the local advertising cache and then sending an advertising request to the advertising server; and
receiving the advertising data returned from the advertising server.

In the method of the present embodiment, the advertising data to be displayed when an APP is launched will be stored a local advertising cache in local, and when running, different processing steps can be selected based on the storing situations of the advertising data in the local advertising cache: if there is no advertising data in the local advertising cache, then an initialization step is executed to store the advertising data from the advertising server to the local for being displayed at next time of launching the APP; if there is the advertising data in the local advertising cache, then the advertising data is directly displayed and then the advertising server is communicated to update the advertising data in the local advertising cache, so that the latest updated advertising data will be displayed at the next time of launching the APP. The advertising data can be selected from a static picture, a dynamic picture or a video.

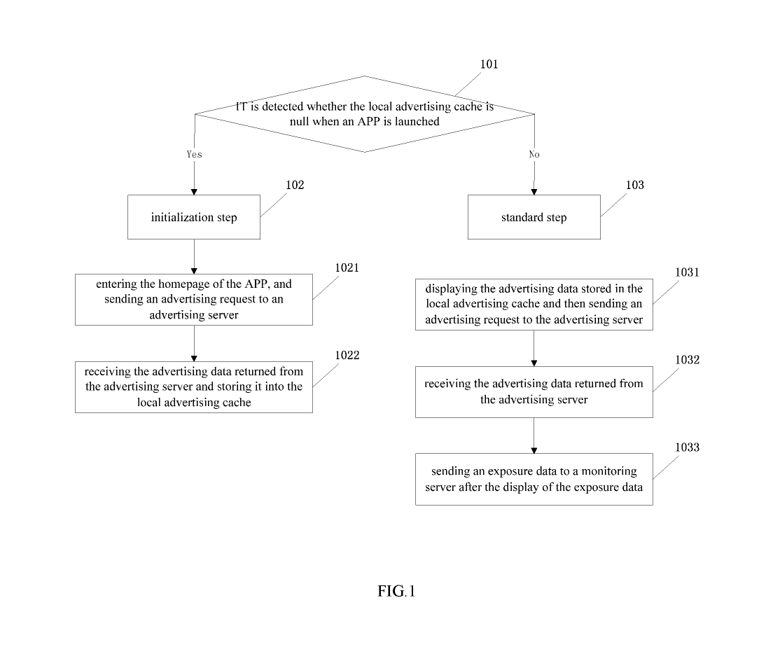

Referring to FIG. 1, it is a schematic flow diagram of a method for preloading of APP launch advertising according to an embodiment of the present disclosure. As a specific embodiment, the method of the embodiment includes:

Step 101: it is detected whether the local advertising cache is null when an APP is launched; if yes, then executing the step 102; if no, then executing the step 103.

In this step, it is first detected whether there is an advertising data stored in the local advertising cache when the APP is launched. Specifically, the local advertising cache is a folder dedicated to store the advertising data which is set in a root directory of the APP. When the local advertising cache is null, that is, there is no advertising data stored, which is a situation of first launching the APP in general, at this time it has to be initialized, namely to execute the step 102 of initialization step. When the local advertising cache is not null, namely there is an advertising data stored, which is a general situation of launching the APP, at this time the step 103 of standard step is executed.

Step 102: an initialization step, includes:

Step 1021: entering the homepage of the APP and sending an advertising request to an advertising server at the same time.

In this step, since there is no advertising data stored in the local advertising cache, the advertising data display is skipped and the homepage of the APP is directly entered; at this time, an advertising request is sent to the advertising server at network. The advertising request typically include a terminal attribute information which typically includes a terminal type, an APP type, an usage record of APP function, etc., for indicating the association between the terminal installed with the APP and the requested advertising data. The advertising server is located at network and stored with various advertising data, in which the corresponding advertising data sending strategy is also preset. By analyzing and marching the attribute information of the advertising request with the advertising sending strategy, the advertising server selects the advertising data to be sent to the terminal and returns the advertising data to the terminal. The contents of the attribute information of advertising request and advertising sending strategy are existed in prior art without detailed description herein.

Step 1022: receiving the advertising data returned from the advertising server and storing it into the local advertising cache.

In this step, the advertising data is stored in the local advertising cache for being displayed at the next time of launching the APP after receiving the advertising data returned from the advertising server, that is to say, the preloading of advertising data is completed.

The initialization step is completed after the advertising data is stored in the local advertising cache. If the advertising server cannot return the advertising data due to network connection issue, then executing the initialization step 102 again at the next time of launching the APP. Thus, the advertising data to be displayed at the next time of launching the APP is only preloaded from the advertising server during the initialization step, but the preloaded advertising data is not displayed at this time of launching the APP. It will take some time and can be affected by the network connection status for the process of preloading the advertising data from the advertising server, if waiting for the completion of the preload and displaying the advertising data at this time of launching, and then the user may wait for too long time when launching the APP. The initialization step in this embodiment not only can ensure the user can successfully and quickly enter into the homepage of the APP, but also can avoid the affection of the process of preloading the advertising data to cause the launching of the APP is slow and not smooth.

Step 103: a standard step, includes:

Step 1031: displaying the advertising data stored in the local advertising cache and then sending an advertising request to the advertising server.

In this step, since the initialization step 102 is executed, there is the advertising data stored in the local advertising cache, when the APP is launched, the advertising data stored in the local advertising cache is displayed; an advertising request is sent to the advertising server at the time of displaying the advertising data, namely to request that the advertising data is displayed at the next time of launching the APP.

Step 1032: receiving the advertising data returned from the advertising server.

In this step, the advertising server returns the advertising data to be displayed at the next time of launching the APP. In the embodiment, in different cases, it can be selected to update the local advertising cache or abandon to update it, wherein the term “update” refers to deleting the original memory in the local advertising cache and storing the latest returned advertising data from the advertising server.

Preferably, in this step, when receiving the advertising data returned from the advertising server, firstly determining whether the advertising data is the same as that in the local advertising cache. If yes, then abandoning to update for avoiding unnecessary consumption of processing resource; if no, then updating the advertising data in the local advertising cache. Specifically, the step of determining whether the advertising data is the same as that in the local advertising cache can includes receiving respective file check codes (MD5 codes) of the received advertising data and the advertising data in the local advertising cache, if both the file check codes are the same, then both the advertising data is considered as the same; otherwise, both the advertising data is considered as different.

Preferably, in this step, analyzing the advertising data to acquire a duration attribute of the advertising data after receiving the advertising data returned from the advertising server, wherein the duration attribute typically is for the dynamic picture or the advertising data in video format, to indicate the duration of one complete display of the advertising data. However, advertising display duration is preset in the APP, wherein the advertising display duration refers to a preset fixed duration for allowing the APP launch advertising to display when the APP is launched. In general, the advertising data is matched with the advertising display duration, that is, the advertising data can be completely displayed within the preset advertising display duration without considerable free time. But in some special cases, it is also occurred the case that the advertising data returned from the advertising server is not matched with the preset advertising display duration, which may significantly affect the user's experience and cannot ensure the benefit of advertiser. Thus, in this step, it is determined whether the duration attribute of the received advertising data is matched with the preset advertising display duration; if yes, then updating the advertising data in the local advertising cache to the advertising data returned from the advertising server; if no, then abandoning to update the local advertising cache.

Step 1033: sending an exposure data to a monitoring server after the display of the exposure data.

In this step, an exposure data corresponding to the displayed advertising data is generated and sent to the monitoring server after the display of the exposure data. The exposure data is used for recoding the relevant display information of the advertising data in the terminal to indicate that the advertising data has been completely displayed in the terminal. After receiving a lot of exposure data regarding the same advertising data from various terminals, the monitoring server will analyze and process it to generate a display situation of the advertising data in all advertising scopes for the business settlement with the produce of the advertising data.

Preferably, in this step, it is detected whether there is established a network communicating connection with the monitoring server before sending the exposure data. Sending the exposure data to the monitoring server directly, if there is an available network communicating connection established between the local and the monitoring server; storing the exposure data into the local, if there is no network communicating connection between the local and the monitoring server or the network communicating connection is failed to work, and then monitoring the status of the network communicating connection between the local and the monitoring server in real time, once the network communicating connection is established or can be worked, sending the exposure data to the monitoring server immediately.

In another embodiment, the standard step further includes:

Analyzing and acquiring the content attribute of the advertising data before displaying the advertising data stored in the local advertising cache. The content attribute corresponds to the advertising display object of the advertising data, typically including the name of the advertising display object, product type of the advertising display object, or the name of the producer of advertising data, etc. There is an association list preset in the local and multiple groups of associations between different advertising data and the subpages of the APP are recorded in the association list. When the subpages of the APP can provide a service regarding the content attribute of the advertising data, namely the advertising display object, it is considered that there is an association between the subpage of the APP and the advertising data. For example, there is such association between a drama playback page of a video playing APP and a propaganda advertising data of the drama; there is such association between a download page of an APP in an APP download platform and a propaganda advertising data of the APP; and there is such association between a display/sale page of a product in a electronic business APP and a propaganda advertising data of the product. The advertising dada and the subpages of the APP between which there is the association are stored in the preset association list.

In the embodiment, searching whether there is a subpage of the APP associated with the content attribute in the preset association list after acquiring the content attribute of the advertising data; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache and not any amending to the advertising data. By the addition of the navigator button, the function of advertising display can be further enriched, so that the user can quickly reach the associated subpage of the APP based on his own preference during the display process of the APP launch advertising. The establishment and generation of the association list depend on the service of server and a lot of synthetic data, and this portion of working is finished by the advertising server. After the association list is generated, the advertising server will push it to the local to be stored. The latest association list is still generated in the advertising server at network, and further the terminal is also communicated with the advertising server while sending an advertising request to the advertising server to synchronously update the local association list with the advertising server, that is, the update request for the association list will be sent to the advertising server together with the advertising request when sending the advertising request, so that at the next time of launching the APP to display the latest advertising data, the latest association list can be used to further improve the advertising display effect.

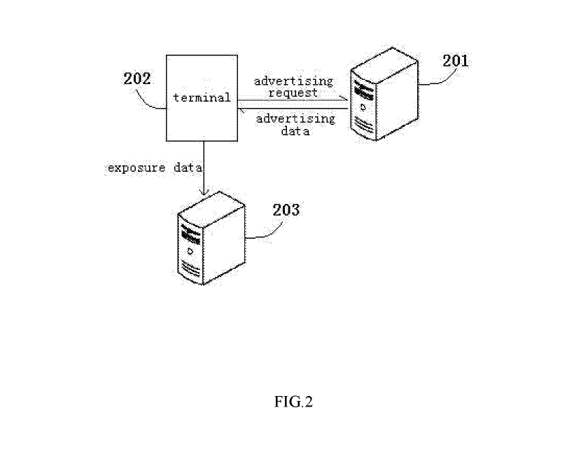

An embodiment of the present disclosure also provides a system for preloading of APP launch advertising. Referring to FIG. 2, it is a schematic view of a system for preloading of APP launch advertising according to an embodiment of the present disclosure. The system of the example comprises an advertising server 201 and a terminal 202, wherein the advertising server 201 can be communicated with the terminal 202 and after receiving the an advertising request from the terminal 202, analyzing the attribute information of the advertising request and combining with the preset advertising data sending strategy to select an advertising data back to the terminal 202.

The terminal 202 can be a mobile terminal or a fixed terminal, in which an extended function module developed by SDK for implementing the specific functions of the embodiment is installed. When the APP is launched, the terminal 202 will first detect whether the local advertising cache is null, and execute an initialization step or a standard step based on the detection result. When the terminal 202 detects that the local advertising cache is null, the initialization step is executed: the terminal 202 enters the homepage of the APP and sends an advertising request to the advertising server 201 at the same time; after the advertising server 201 selects an advertising data and sends it back to the terminal 202 based on the advertising request; and the terminal 202 receives the advertising data and stores the data into the local advertising cache. When the terminal 202 detects that the local advertising cache is not null, then the standard step is executed: the terminal 202 displays the advertising data stored in the local advertising cache and sends an advertising request to the advertising server at the same time; and after the advertising sever 201 returns an advertising data based on the advertising request, the terminal 202 deletes the original data from the local advertising cache and receives the advertising data and stores the data into the local advertising cache, that is, the advertising data is updated and stored in the local advertising cache.

Preferably, during the execution of standard step, the terminal 202 is further used for after the end of the advertising data display, sending an exposure data to the monitoring server 203 at network, wherein the exposure data is used for statistics of the advertising display situation by the monitoring server 203. Preferably, the exposure data is generated by loading a tracking pixel algorithm module. After the monitoring server 203 receives a lot of exposure data regarding the same advertising data from various terminals, the monitoring server 203 will analyze and process it to generate a display situation of the advertising data in all advertising scopes for the business settlement with the produce of the advertising data. To ensure the accurate sending of the exposure data, before sending the exposure data, the terminal 202 will also detect whether there is established a network communicating connection with the monitoring server 203; if yes, then directly sending the exposure data to the monitoring server 203; if no, then storing the exposure data into the local and monitoring the status of the network communicating connection between the local and the monitoring server 203 in real time, once the network communicating connection is established or can be worked, sending the exposure data to the monitoring server 203 immediately.

Preferably, during the execution of standard step, the terminal 202 will first determine whether the advertising data is the same as that in the local advertising cache after receiving the advertising data returned from the advertising server 201; if yes, then abandoning to update the local advertising cache; if no, then updating the advertising data in the local advertising cache to the advertising data returned from the advertising server 201.

Preferably, during the execution of standard step, the terminal 202 will first analyze and acquire a duration attribute of the advertising data and determine whether the duration attribute is matched with a preset advertising display duration after receiving the advertising data returned from the advertising server 201; if yes, updating the advertising data in the local advertising cache to the advertising data returned from the advertising server 201; if no, abandoning update of the local advertising cache.

Preferably, during the execution of standard step, the terminal 202 will analyze and acquire a content attribute of the acquired advertising data and search whether there is a subpage of the APP associated with the content attribute in a preset association list before displaying the advertising data stored in the local advertising cache; if yes, adding a navigator button into the displayed advertising data, wherein the navigator button is used for ending the advertising display and directly jumping to the subpage of the APP when receiving an instruction that the user selects the button; if no, display the advertising data stored in the local advertising cache directly. Further, the terminal 202 will synchronously update the local association list with the advertising server 201 while sending the advertising request to the advertising server 201.

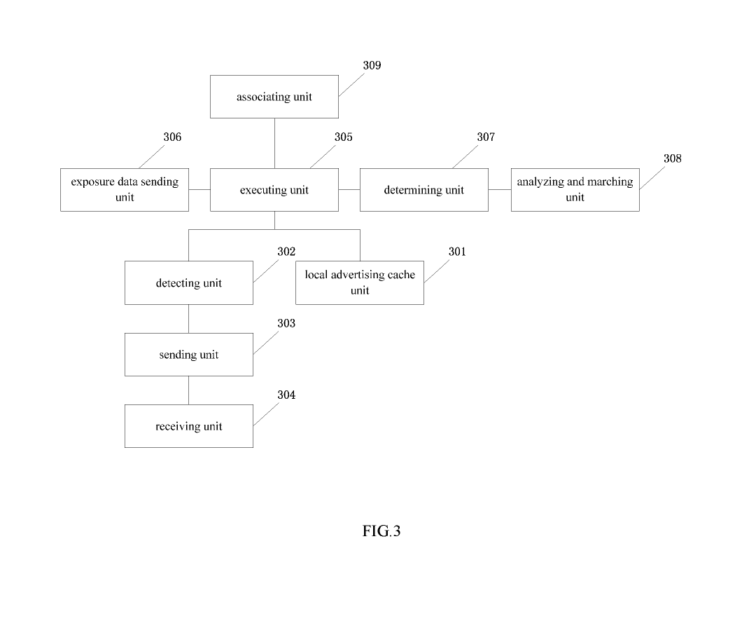

Another aspect of the present disclosure also provides an apparatus for preloading of APP launch advertising. Referring to FIG. 3, this is a schematic view of an apparatus for preloading of APP launch advertising according to an embodiment of the present disclosure. The apparatus for preloading of APP launch advertising of the embodiment includes:

a local advertising cache unit 301, for storing an advertising data;
a detecting unit 302; for detecting whether the local advertising cache unit is null when an APP is launched;
a sending unit 303, for sending an advertising request to an advertising server at network;
a receiving unit 304, for receiving the advertising data returned from the advertising server;
an executing unit 305, for if it is detected by the detecting unit that the local advertising cache is null, then entering the homepage of the APP and making the sending unit to send an advertising request to the advertising server at network at the same time; and if it is detected by the detecting unit that the local advertising cache is not null, then displaying the advertising data stored in the local advertising cache unit and then making the sending unit to send an advertising request to the advertising server; and making the receiving unit to receive the advertising data returned from the advertising server.

Preferably, the apparatus further includes an exposure data sending unit 306, for sending an exposure data to the monitoring server at network after the display of the exposure data, wherein the exposure data is used for statistics of the advertising display situation by the monitoring server. Further, the exposure data sending unit 306 is further used for checking whether the network communicating connection with the monitoring server is established; if yes, then sending the exposure data to the monitoring server directly; if no, then storing the exposure data in local and sending the exposure data to the monitoring server immediately once the network communicating connection with the monitoring server is established.

Preferably, the apparatus further includes a determining unit 307, for determining whether it is the same between the advertising data returned from the advertising server and the advertising data in the local advertising cache unit 301; if yes, then abandoning update of the local advertising cache unit 301; if no, then updating the advertising data in the local advertising cache unit 301 to the advertising data returned from the advertising server.

Preferably, the apparatus further includes a analyzing and marching unit 308, for analyzing a duration attribute of the advertising data returned from the advertising server and determining whether the duration attribute is matched with a preset advertising display duration; if yes, then updating the advertising data in the local advertising cache unit 301 to the advertising data returned from the advertising server; if no, then abandoning update of the local advertising cache unit 301.

Preferably, the apparatus further includes an associating unit 309, for analyzing a content attribute of the acquired advertising data before the executing unit 305 displaying the advertising data stored in the local advertising cache unit 301; and searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache. Further, the associating unit 309 is used for analyzing a duration attribute of the advertising data returned from the advertising server and synchronizing the association list in local with that in the advertising server at the time of the sending unit 303 sending the advertising request to the advertising server.

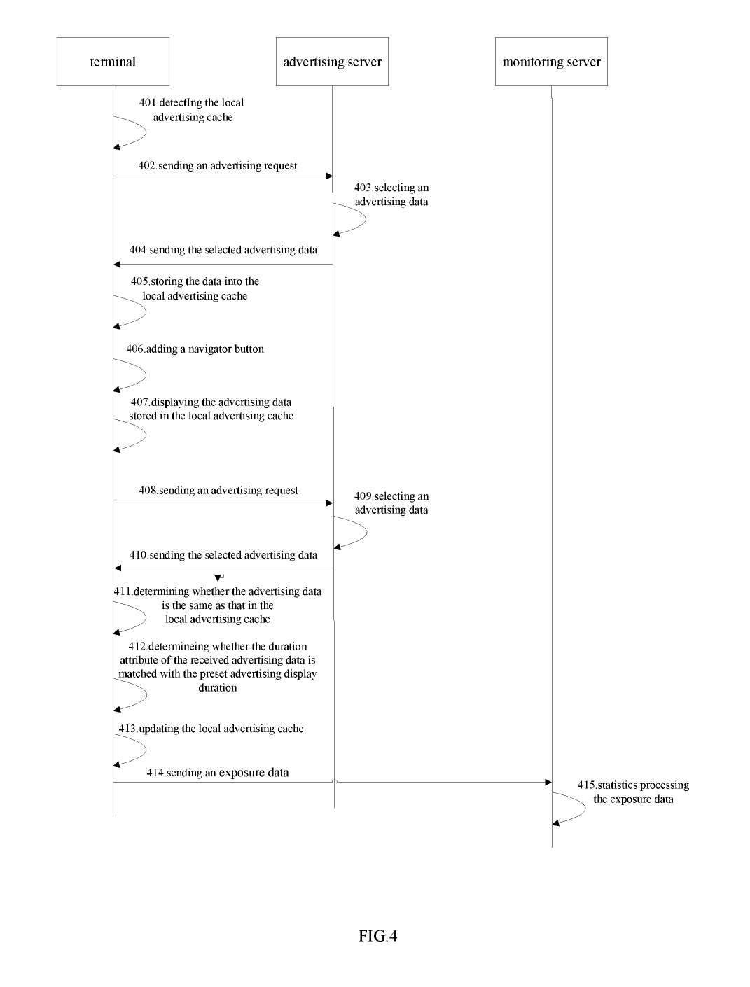

Based on the abovementioned embodiment of the system, referring to FIG. 4, a method for preloading of APP launch advertising of an embodiment of the disclosure includes:

Step 401: the local advertising cache is detected when an APP is launched, that is, it is detected whether the folder dedicated to store the advertising data which is set in a root directory of the APP is null; if yes, then executing an initialization step; if no, then executing a standard step.

The initialization step: in this step, there is no advertising data in the local advertising cache.

Step 402: the terminal enters the homepage of the APP and sends an advertising request to an advertising server at the same time.

Step 403: the advertising server selects an advertising data sent to the terminal after receiving the advertising request. The advertising data is selected according to the terminal attribute information, such as terminal type, APP type, usage records of APP function, etc. and the preset advertising data sending strategy. The terminal attribute information is included in the advertising request.

Step 404: the advertising server sends the selected advertising data back to the terminal.

Step 405: the terminal receives the advertising data returned from the advertising server and stores the data into the local advertising cache. The advertising data stored in the local advertising cache folder is used for displayed at the next time of launching the APP, and the initialization is over until now.

The standard step: in this step, there is advertising data stored in the local advertising cache folder.

Step 406: the terminal analyzes and acquires a content attribute of the acquired advertising data when an APP is launched; and searches whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then making not any amendment to the advertising data.

Step 407: the terminal reads and displays the advertising data stored in the local advertising cache folder to the user.

Step 408: after displaying the advertising data, the terminal sends an advertising request to the advertising server to request the advertising data for displaying at the next time of launching the APP, that is, to update the advertising data in the local advertising cache folder.

Step 409: the advertising server selects an advertising data sent to the terminal after receiving the advertising request.\

Step 410: the advertising server sends the selected advertising data back to the terminal.

Step 411: the terminal first determines whether the advertising data is the same as that in the local advertising cache after receiving the advertising data returned from the advertising server, that is, comparing the respective MD5 check code; if yes, then abandoning to update for avoiding the unnecessary consumption of processing resource; if no, then executing the step 413.

Step 412: the terminal further analyzes a duration attribute of the advertising data returned from the advertising server, wherein the duration attribute typically is for the dynamic picture or the advertising data in video format, to indicate the duration of one complete display of the advertising data. However, an advertising display duration is preset in the APP, wherein the advertising display duration refers to a preset fixed duration for allowing the APP launch advertising to display when the APP is launched. The terminal determines whether the duration attribute of the received advertising data is matched with the preset advertising display duration; if yes, then executing the step 413; if no, then abandoning to update of the local advertising cache.

Step 413: the terminal receives the advertising data returned from the advertising server, and then deletes the existing data in the local advertising cache folder and stores the advertising data returned from the advertising server into the local advertising cache folder for displaying at the next time of launching the APP.

Step 414: the terminal generates an exposure data corresponding to the displayed advertising data, and sends the exposure data to the monitoring server after the display of the exposure data. The exposure data is used for recording the relevant display information of the advertising data in the local terminal to indicate a complete display of the advertising data.

Step 415: the monitoring server receives the exposure data returned from the terminal, combines with a lot of exposure data corresponding the same advertising data from various terminals to perform a statistics process to generate the display situation of the advertising data in the whole advertising scopes.

Another aspect of the present disclosure also provides a device, as an embodiment includes:

one or more processor(s); and
a memory for storing an operating instruction;
wherein the one or more processor(s) is/are configured to acquire the operation instruction from the memory to execute:
detecting whether the local advertising cache is null when an APP is launched; if yes, then executing a initialization step; if no, then executing a standard step;
wherein the initialization step includes:
entering the homepage of the APP and sending an advertising request to an advertising server at the same time; and
receiving advertising data returned from the advertising server and storing the data into the local advertising cache;
the standard step includes:
displaying the advertising data stored in the local advertising cache and then sending an advertising request to the advertising server; and
receiving the advertising data returned from the advertising server.

In some embodiments, the processor is further used for executing:

sending an exposure data to the monitoring server after the display of the exposure data, wherein the exposure data is used for statistics of the advertising display situation by the monitoring server.

In some embodiments, the processor is further used for executing:

checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

In some embodiments, the processor is further used for executing:

determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

In some embodiments, the processor is further used for executing:

analyzing a duration attribute of the advertising data returned from the advertising server; and
determining whether the duration attribute is matched with a preset advertising display duration; if yes, then updating the advertising data in the local advertising cache to the advertising data returned from the advertising server; if no, then abandoning update of the local advertising cache.

In some embodiments, the processor is further used for executing:

analyzing a content attribute of the acquired advertising data; and
searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache.

In some embodiments, the processor is further used for executing:

synchronizing the association list in local with that in the advertising server at the time of sending the advertising request to the advertising server.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer readable storage medium. When the computer program is executed by CPU, the above functions defined in the methods of the present disclosure are executed.

Furthermore, the above described method steps and system units can also be implemented by using a controller and a computer readable storage medium for storing a computer program to make the controller to implement the above steps or unit functions.

Additionally, it should be appreciated that the computer readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical sections, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of method or algorithm described herein may be contained directly in hardware, software module executed by a processor, or both. The software module may reside in RAM memory, flash memory, ROM memory, EPROM memory, EEPROM memory, registers, hard disk, removable disk, CDROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer readable medium. Computer readable medium includes both computer storage medium and communication medium, and the communication medium includes any medium contributed to transmit a computer program from one place to another. The storage medium may be any available medium accessible by a general purpose or special purpose computer. As an example without any restriction, the computer readable medium can comprise RAM, ROM, EEPROM, CDROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CDROM disc (CD), laser disc, optical disc, digital versatile disc (DVD), floppy disk and Blue ray disc where the disk usually reproduces data magnetically and the disc reproduces data optically with lasers. Combinations of the above should also be included within the scope of computer readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above described embodiments may be accomplished by hardware or by instructing relevant hardware via program, and the program may be stored in a computer readable storage medium such as read only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for preloading of APP launch advertising, comprising:
detecting whether the local advertising cache is null when an APP is launched; if yes, then executing an initialization step; if no, then executing a standard step;
wherein the initialization step comprising:
entering the homepage of the APP and sending an advertising request to an advertising server; and
receiving advertising data returned from the advertising server and storing the advertising data into the local advertising cache;
where in the standard step comprising:
displaying the advertising data stored in the local advertising cache and then sending an advertising request to the advertising server; and
receiving the advertising data returned from the advertising server.

2. The method according to claim 1, wherein the method further comprising:
sending an exposure data to a monitoring server after the display of the exposure data, wherein the exposure data is used for statistics of the advertising display situation by the monitoring server.

3. The method according to claim 2, where in the step of sending an exposure data to a monitoring server further comprising:
Checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

4. The method according to claim 1, wherein the standard step further comprising:
determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

5. The method according to claim 1, wherein the standard step further comprising:
analyzing a duration attribute of the advertising data returned from the advertising server; and
determining whether the duration attribute is matched with a preset advertising display duration; if yes, then updating the advertising data in the local advertising cache to the advertising data returned from the advertising server; if no, then abandoning update of the local advertising cache.

6. The method according to claim 1, wherein before displaying the advertising data stored in the local advertising cache, the method further comprising:
analyzing a content attribute of the acquired advertising data; and
searching whether there is a subpage of the APP associated with the content attribute in a preset association list; if yes, then adding a navigator button into the displayed advertising data, wherein the navigator button is used for ending the advertising display and jumping to the subpage of the APP directly when receiving an instruction that the user selects the button; if no, then display the advertising data stored in the local advertising cache directly.

7. The method according to claim 6, wherein the standard step further comprising:
synchronizing the association list in local with that in the advertising server at the time of sending the advertising request to the advertising server.

8. A system for preloading of APP launch advertising, comprising: an advertising server and a terminal, wherein:
the advertising server is used for sending an advertising data to the terminal when receiving an advertising request of the terminal; and
the terminal is used for if it is detected that the local advertising cache is null, then entering the homepage of the APP and sending an advertising request to the advertising server; and receiving the advertising data returned from the advertising server and storing the data into the local advertising cache; and if it is detected that the local advertising cache is not null, then displaying the advertising data stored in the local advertising cache and then sending an advertising request to the advertising server; and receiving the advertising data returned from the advertising server.

9. The system according to claim 8, wherein the terminal is further used for sending an exposure data to a monitoring server after the display of the exposure data, wherein the exposure data is used for statistics of the advertising display situation by the monitoring server.

10. The system according to claim 9, wherein the terminal is further used for checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

11. The system according to claim 8, wherein the terminal is further used for determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

12. The system according to claim 8, wherein the terminal is further used for analyzing a duration attribute of the advertising data returned from the advertising server; and determining whether the duration attribute is matched with a preset advertising display duration; if yes, then updating the advertising data in the local advertising cache to the advertising data returned from the advertising server; if no, then abandoning update of the local advertising cache.

13. The system according to claim 8, wherein the terminal is further used for analyzing a content attribute of the acquired advertising data before displaying the advertising data stored in the local advertising cache and searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache.

14. The system according to claim 13, wherein the terminal is further used for synchronizing the association list in local with that in the advertising server at the time of sending the advertising request to the advertising server.

15. A device, comprising:
one or more processor(s); and
a memory for storing an operating instruction;
wherein the one or more processor(s) is/are configured to acquire the operation instruction from the memory to execute:
detecting whether the local advertising cache is null when an APP is launched; if yes, then executing an initialization step; if no, then executing a standard step;
wherein the initialization step comprising:
entering the homepage of the APP and sending an advertising request to an advertising server; and
receiving advertising data returned from the advertising server and storing the advertising data into the local advertising cache;
where in the standard step comprising:
displaying the advertising data stored in the local advertising cache and then sending an advertising request to the advertising server; and
receiving the advertising data returned from the advertising server.

16. The device according claim 15, wherein the processor is further used for executing:
sending an exposure data to a monitoring server after the display of the exposure data, wherein the exposure data is used for statistics of the advertising display situation by the monitoring server.

17. The device according claim 15, wherein the processor is further used for executing:
checking whether the network communicating connection with the monitoring server is established; if yes, then sending the exposure data to the monitoring server directly; if no, then storing the exposure data in local and sending the exposure data to the monitoring server once the network communicating connection with the monitoring server is established.

18. The device according claim 15, wherein the processor is further used for executing:
determining whether it is the same between the advertising data returned from the advertising server and the advertising data in the local advertising cache; if yes, then abandoning update of the local advertising cache; if no, then updating the advertising data in the local advertising cache to the advertising data returned from the advertising server.

19. The device according claim 15, wherein the processor is further used for executing:
analyzing a duration attribute of the advertising data returned from the advertising server; and
determining whether the duration attribute is matched with a preset advertising display duration; if yes, then updating the advertising data in the local advertising cache to the advertising data returned from the advertising server; if no, then abandoning update of the local advertising cache.

20. The device according claim 15, wherein the processor is further used for executing:
analyzing a content attribute of the acquired advertising data; and
searching whether there is a subpage of the APP associated with the content attribute in a preset association list; if yes, then adding a navigator button into the displayed advertising data, wherein the navigator button is used for ending the advertising display and directly jumping to the subpage of the APP, when receiving an instruction that the user selects the button; if no, then directly display the advertising data stored in the local advertising cache.
